(19) United States
(12) Patent Application Publication
(10) Pub. No.: US 2025/0329290 A1
(43) Pub. Date: Oct. 23, 2025

(54) ELECTRONIC DEVICE AND METHOD FOR CHANGING CIRCUIT CONNECTED TO DISPLAY PANEL

(71) Applicant: Samsung Electronics Co., Ltd., Suwon-si (KR)

(72) Inventors: Gyeongsun LEE, Suwon-si (KR); Hyunjun PARK, Suwon-si (KR)

(21) Appl. No.: 19/258,190

(22) Filed: Jul. 2, 2025

Related U.S. Application Data
(63) Continuation of application No. PCT/KR2023/019661, filed on Dec. 1, 2023.

(30) Foreign Application Priority Data
Jan. 20, 2023 (KR) 10-2023-0008841
Jan. 31, 2023 (KR) 10-2023-0013312

(51) Int. Cl. G09G 3/20; G09G 3/32

(52) U.S. Cl. CPC G09G 3/2096; G09G 3/32; G09G 2310/08; G09G 2354/00

(57) ABSTRACT

An electronic device may include: a memory for storing instructions; a processor including processing circuitry; a display panel including a plurality of sub-pixels; and a control circuit including a gate driver for controlling the operation of each of the plurality of sub-pixels, and a source driver for controlling data voltage for each of the plurality of sub-pixels. The source driver may include: a channel circuit set including a plurality of channel circuits connected to each of the plurality of sub-pixels, and a first channel circuit disconnected from the plurality of sub-pixels; and a sensing circuit.

### CROSS-REFERENCE TO RELATED APPLICATIONS

This application is a continuation application of International Application No. PCT/KR2023/019661, filed on Dec. 1, 2023, in the Korean Intellectual Property Receiving Office, and claiming priority to Korean Patent Application No. 10-2023-0008841 filed Jan. 20, 2023, and Korean Patent Application No. 10-2023-0013312, filed on Jan. 31, 2023, the disclosures of which are all hereby incorporated by reference herein in their entireties.

### TECHNICAL FIELD

Certain example embodiments may relate to an electronic device and/or a method for changing a circuit connected to a display panel.

### BACKGROUND

An electronic device may include a display panel. For example, the electronic device may include a display driving circuit that is operably (or operatively) coupled with the display panel. For example, the display driving circuit may display an image obtained from a processor of the electronic device on the display panel.

The above-described information may be provided as a related art for the purpose of helping understanding of the present disclosure. No argument or decision is made as to whether any of the above description may be applied as a prior art related to the present disclosure.

### SUMMARY

An electronic device may comprise a processor comprising processing circuitry. The electronic device may comprise a display panel including a plurality of sub-pixels. The electronic device may comprise a control circuit including a gate driver for controlling driving of each of the plurality of sub-pixels and a source driver for controlling a data voltage for each of the plurality of sub-pixels. The source driver may include a channel circuit set including a plurality of channel circuits respectively connected, directly or indirectly, to the plurality of sub-pixels and a first channel circuit disconnected from the plurality of sub-pixels, and a sensing circuit. The control circuit may be configured to identify an event for changing a first state that the display panel is off to a second state that the display panel is on. The control circuit may be configured to, in response to the event, respectively identify, via the sensing circuit, signals outputted via the plurality of channel circuits in the first state. The control circuit may be configured to disconnect a second channel circuit outputting a signal having a voltage different from a reference voltage from among the plurality of channel circuits in the first state from a sub-pixel connected, directly or indirectly, to the second channel circuit, and connect the sub-pixel to the first channel circuit. The control circuit may be configured to display an image on the display panel based on the plurality of channel circuits including the first channel circuit in the second state changed from the first state based on the event.

A method performed by an electronic device may comprise identifying an event for changing a first state that a display panel including a plurality of sub-pixels of the electronic device is off to a second state that the display panel is on. The method may comprise, in response to the event, respectively identifying signals outputted via a plurality of channel circuits in a source driver of the electronic device, via a sensing circuit in the source driver, in the first state. The method may comprise disconnecting a second channel circuit outputting a signal having a voltage different from a reference voltage from among the plurality of channel circuits in first state from a sub-pixel connected, directly or indirectly, to the second channel circuit, and connecting the sub-pixel to the first channel circuit. The method may comprise displaying an image on the display panel based on the plurality of channel circuits including the first channel circuit in the second state changed from the first state according to the event.

### BRIEF DESCRIPTION OF THE DRAWINGS

FIG. 1 is a block diagram of an electronic device in a network environment according to various example embodiments.

FIG. 2 is a block diagram of a display module according to various example embodiments.

FIG. 3 illustrates an example of a simplified block diagram of an example electronic device.

FIG. 4 illustrates an example of a defect in a display panel of an example electronic device.

FIG. 5A illustrates an example of a display driving circuit including a channel circuit set.

FIG. 5B illustrates an example of a timing diagram for sensing and repairing operations of a display driving circuit including a channel circuit set.

FIG. 6A is a flowchart illustrating an example of a method of changing a channel circuit of a source driver connected to a display panel.

FIG. 6B is a flowchart illustrating an example of a method of sequentially sensing a voltage of channel circuits in a source driver.

FIG. 7A illustrates an example of a method of sequentially sensing a voltage of channel circuits in a source driver.

FIG. 7B illustrates an example of a timing diagram for an operation of outputting an image by changing a channel circuit connected to a display panel of a source driver.

FIG. 8 illustrates an example of a timing diagram for a control circuit for outputting an image by changing a channel circuit connected to a display panel of a source driver.

FIG. 9 illustrates an example of an output state of a display panel according to a method of changing a channel circuit connected to the display panel of a source driver.

FIG. 10 illustrates an example of a display driving circuit including a channel circuit set.

### DETAILED DESCRIPTION

Terms used in the present disclosure are used only to describe a specific embodiment, and may not be intended to limit a range of another embodiment. A singular expression may include a plural expression unless the context clearly means otherwise. The terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term (e.g., a processor, a display, a driver, a block, a circuit, and the like) referring to a configuration of a device, a term (e.g., a step, an operation, a procedure) for a calculation state, a term (e.g., a signal, information, data, a stream, a user input, an input, a touch input, a gesture, and the like) referring to a signal, a term (e.g., a value, and the like) for referring to data, used in the description below, are exemplified for convenience of explanation. Therefore, the present disclosure is not limited to terms described below, and another term having equivalent technical meanings may be used.

Also, in the present disclosure, the term ‘greater than’ or ‘less than’ may be used to determine whether a particular condition is satisfied or fulfilled, but this is only a description to represent an example and does not exclude a description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. Also, hereinafter, ‘A’ to ‘B’ means at least one of elements from A (including A) to B (including B).

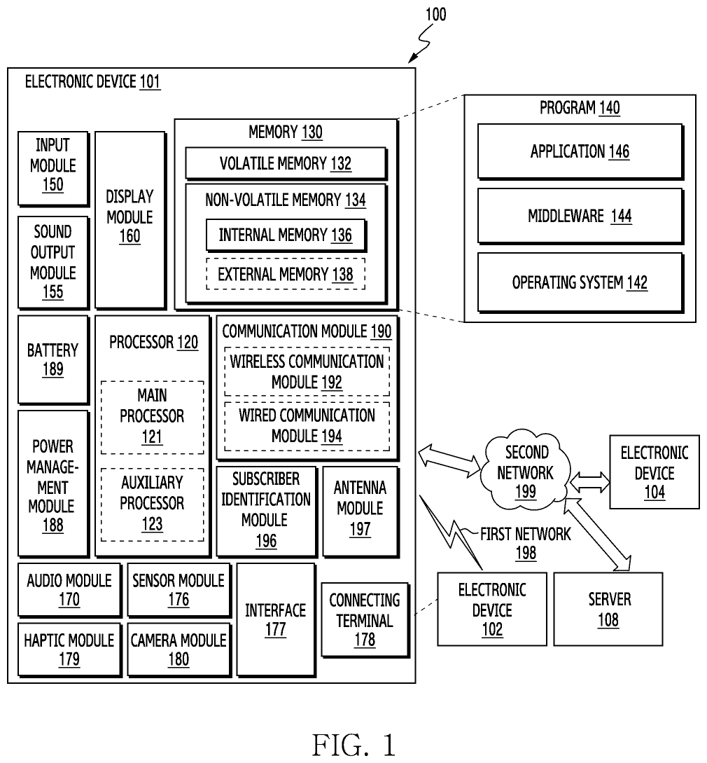

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190 comprising communication circuitry) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

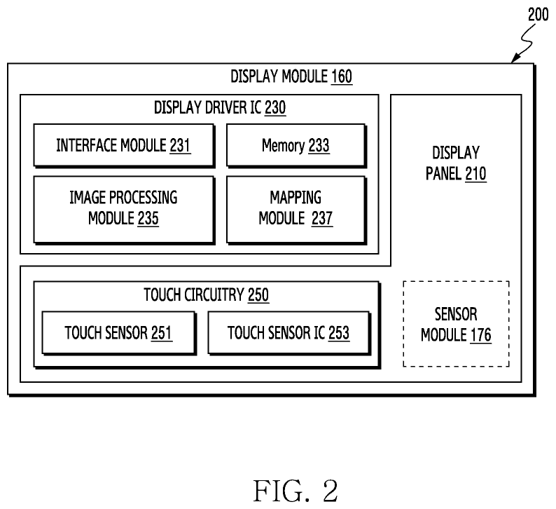

FIG. 2 is a block diagram 200 illustrating the display module 160 according to various embodiments. Referring to FIG. 2, the display module 160 may include a display 210 and a display driver integrated circuit (DDI) 230 to control the display 210. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, according to an embodiment, the image information may be received from the processor 120 (e.g., the main processor 121 (e.g., an application processor)) or the auxiliary processor 123 (e.g., a graphics processing unit) operated independently from the function of the main processor 121. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor 251 may detect (e.g., measure) a change in a signal (e.g., a voltage, a quantity of light, a resistance, or a quantity of one or more electric charges) corresponding to the certain position on the display 210. The touch circuitry 250 may provide input information (e.g., a position, an area, a pressure, or a time) indicative of the touch input or the hovering input detected via the touch sensor 251 to the processor 120. According to an embodiment, at least part (e.g., the touch sensor IC 253) of the touch circuitry 250 may be formed as part of the display 210 or the DDI 230, or as part of another component (e.g., the auxiliary processor 123) disposed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be disposed between pixels in a pixel layer of the display 210, or over or under the pixel layer.

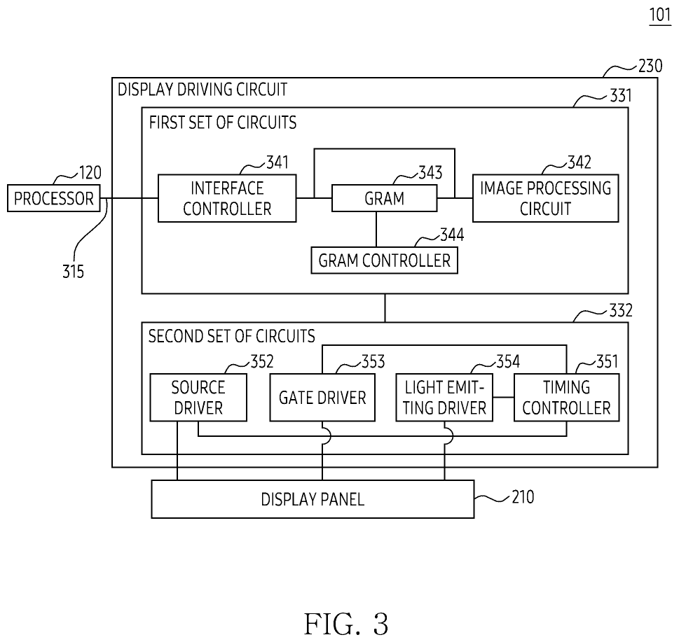

FIG. 3 illustrates an example of a simplified block diagram of an electronic device.

Referring to FIG. 3, an electronic device 101 may include a processor 120, a display driving circuit 230, and a display panel 210. The display driving circuit 230 may be referred to as a DDI or a control circuit. The display panel 210 may be referred to as a display.

For example, the processor 120 may be used to obtain an image. For example, the processor 120 may provide the image to the display driving circuit 230. For example, the processor 120 may provide at least one command related to a display of the image to the display driving circuit 230. For example, the processor 120 may include at least a portion of the processor 120 of FIG. 1.

For example, the processor 120 may include a central processing unit (CPU), a graphics processing unit (GPU), or a display controller (or a display processing unit (DPU)) configured to process an image obtained from volatile memory in a suitable format for the display panel 210. For example, the processor 120 may be operatively (or operably) coupled with the display driving circuit 230. For example, the processor 120 being operatively coupled with the display driving circuit 230 may indicate that the processor 120 is directly connected to the display driving circuit 230. For example, the processor 120 being operatively coupled with the display driving circuit 230 may indicate that the processor 120 is connected to the display driving circuit 230 via another component of the electronic device 101. For example, the processor 120 may be connected to the display driving circuit 230 via an interface 315. For example, the interface 315 may be used to transmit an image from the processor 120 to the display driving circuit 230. For example, the interface 315 may be a display serial interface (DSI) of a mobile industry process interface (MIPI) alliance. However, an embodiment of the present disclosure is not limited thereto. For example, the processor 120 being operatively coupled with the display driving circuit 230 may indicate that the display driving circuit 230 operates based on instructions executed by the processor 120. For example, the processor 120 being operatively coupled with the display driving circuit 230 may indicate that the display driving circuit 230 is controlled by the processor 120. For example, the processor 120 may display an image on the display panel 210 using the display driving circuit 230 based on a video mode of the DSI.

For example, the display driving circuit 230 may process the image based on a characteristic of the image and/or a characteristic of the display panel 210. For example, the display driving circuit 230 may provide signals for displaying the image to the display panel 210. For example, the display driving circuit 230 may include at least a portion of the DDI (e.g., the DDI 230 of FIG. 2). For example, the display driving circuit 230 may be operatively coupled with the display panel 210. For example, the display driving circuit 230 being operatively coupled with the display panel 210 may indicate that the display driving circuit 230 is connected to the display panel 210. For example, the display driving circuit 230 being operatively coupled with the display panel 210 may indicate that the display panel 210 is controlled by the display driving circuit 230. However, it is not limited thereto.

For example, the display driving circuit 230 may include a first set 331 of circuits for processing the image obtained from the processor 120. For example, the first set 331 may be connected to the processor 120 of the processor 120 and the display panel 210. For example, the display driving circuit 230 may include a second set 332 of circuits to obtain the processed image from the first set 331 and provide signals for displaying the obtained image to the display panel 210. For example, the second set 332 may be connected to the display panel 210 of the processor 120 and the display panel 210. For example, the second set 332 may be used to execute initializing a gate, applying the data voltage to the initialized gate, and emitting a light emitting diode. For example, the gate may indicate a gate of a transistor related to each of a plurality of sub-pixels included in the display panel 210. The light emitting diode may indicate a diode emitting light related to each of the plurality of sub-pixels.

For example, the first set 331 may include an interface controller 341 connected to the processor 120 via the interface 315. For example, the interface controller 341 may be used to provide the image obtained from the processor 120 to an image processing circuit 342 or graphic random access memory (GRAM) 343 and to provide a command obtained from the processor 120 to a command controller (not illustrated). For example, the interface controller 341 may be included in the interface module 231 of FIG. 2.

For example, the first set 331 may include the image processing circuit 342. For example, the image processing circuit 342 may process the image to adjust resolution, brightness, and/or a size of the image from the processor 120. For example, the processed image may be provided to the second set 332. For example, the image processing circuit 342 may be included in the image processing module 235 of FIG. 2.

For example, the first set 331 may further include the GRAM 343 and a GRAM controller 344. For example, the GRAM 343 may be used to store or record the image obtained from the processor 120. For example, the GRAM controller 344 may be used to control the GRAM 343. The GRAM 343 and the GRAM controller 344 may be included in the memory 233 of FIG. 2.

For example, the second set 332 may include a timing controller 351. For example, the timing controller 351 may be used to provide a synchronization signal (or a timing signal) to the GRAM controller 344, a source driver 352, a gate driver 353, and/or a light emitting driver 354. For example, the synchronization signal may include a vertical synchronization signal (Vsync) and a horizontal synchronization signal (Hsync). For example, the synchronization signal may be generated by the timing controller 351 or by a synchronization signal generation circuit positioned outside the display driving circuit 230. For example, the timing controller 351 may be used to provide signals for controlling the source driver 352, the gate driver 353, and/or the light emitting driver 354. For example, the timing controller 351 may further include at least one signal generation circuit (as exemplified via the descriptions below). For example, the at least one signal generation circuit in the second set 332 may be positioned outside the timing controller 351. For example, at least a portion of the second set 332 may be included in the mapping module 237 of FIG. 2.

For example, the second set 332 may include the source driver 352. For example, the source driver 352 may be used to provide the data voltage to be applied to a gate. For example, the source driver 352 may be used to provide the data voltage corresponding to a specific gradation in a gradation that may be implemented by the sub-pixel of the display panel 210. For example, the gradation implemented by each of the sub-pixels may be changed according to a magnitude of the data voltage.

For example, the second set 332 may include a gate driver 353. For example, the gate driver 353 may be used to provide a gate voltage to the display panel 210. The gate voltage may include a voltage for driving (e.g., on/off) a transistor included in the sub-pixel.

For example, the second set 332 may include a light emitting driver 354. For example, the light emitting driver 354 may be used to provide the light emitting signal to the display panel 210.

Referring to the above, the electronic device (e.g., a terminal) 101 may include the display panel 210, and may include the display driving circuit 230 (or the control circuit) for controlling and driving the display panel 210. The display driving circuit 230 may include the source driver 352 for controlling the data voltage for the sub-pixels of the display panel 210. The source driver 352 may include a plurality of channel circuits connected to each of the sub-pixels. The channel circuit may be electrically damaged, according to an external factor (e.g., an electrical overstress (EOS) or an electro static discharge (ESD)). For example, an amplifier included in the channel circuit (or a component (e.g., a transistor) inside the amplifier) may be damaged by the EOS or the ESD.

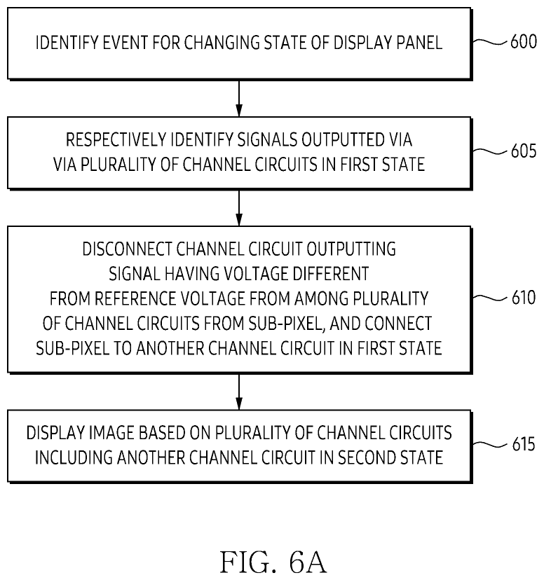

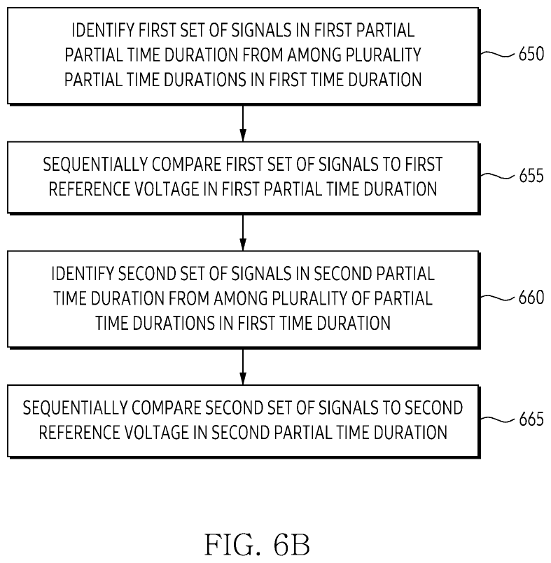

Although not illustrated in FIG. 3, the electronic device 101 may include memory storing instructions executed by the processor 120 and/or the display driving circuit 230 (or the control circuit). For example, the memory storing the instructions may be included in the processor 120. Also, for example, the memory storing the instructions may be included in the display driving circuit 230 (or the control circuit). Also, for example, the memory storing the instructions may be a component other than the processor 120 and the display driving circuit 230 (or the control circuit). For example, the memory storing the instructions may include at least a portion of the memory 130 of FIG. 1. For example, the instructions may cause an operation (e.g., at least a portion of operations of FIGS. 6A and 6B) of the electronic device 101.

Hereinafter, a device and a method for changing a channel circuit connected to a sub-pixel of a display panel to another channel circuit according to an embodiment of the present disclosure (hereinafter, a device and a method for changing a channel circuit) will be described. The device and the method for changing the channel circuit according to an embodiment of the present disclosure may be recovered via the another channel circuit corresponding to damage to the channel circuit caused by the external factor such as the EOS or the ESD. Accordingly, the device and the method for changing the channel circuit according to an embodiment of the present disclosure may reduce a defect rate that may occur in a process of producing and manufacturing an electronic device. Also, the device and the method for changing the channel circuit according to an embodiment of the present disclosure may improve the defect displayed via the display even when damage occurs during the process of using the electronic device.

The technical problems to be achieved in this document are not limited to those described above, and other technical problems not mentioned herein will be clearly understood by those having ordinary knowledge in the art to which the present disclosure belongs, from the following description.

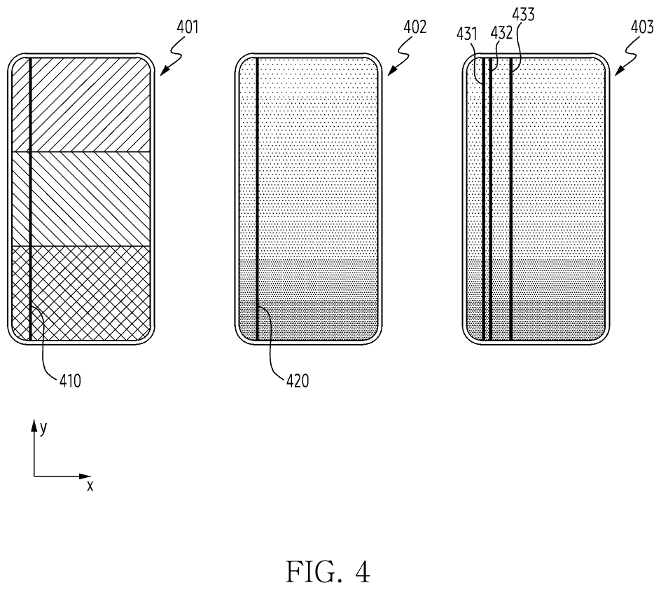

FIG. 4 illustrates an example of a defect in a display panel of an electronic device. The electronic device of FIG. 4 may include at least a portion of the electronic device 101 of FIG. 1. The display panel of FIG. 4 may include the display panel 210 of FIG. 2 (or the display panel 210 of FIG. 3).

Referring to FIG. 4, examples 401, 402, and 403 of a defect that may occur in the display panel 210 are illustrated. The defect may occur in a manufacturing process producing the electronic device 101 or in a process of using the electronic device 101. For example, the defect may include damage to channel circuits in a source driver (e.g., the source driver 352 of FIG. 3) of the electronic device 101 based on electrical damage (e.g., EOS or ESD).

Referring to the example 401, a defect 410 may be formed on the display panel 210 of the electronic device 101. For example, the defect 410 may be formed in a vertical direction (e.g., in a y-axis direction) in an area of the display panel 210. The display panel 210 of the example 401 may be divided into three partial areas, and each of the divided partial areas may output a different image. The defect 410 may be formed over the three partial areas.

Referring to the example 402, a defect 420 may be formed on the display panel 210 of the electronic device 101. For example, the defect 420 may be formed in a vertical direction (e.g., in a y-axis direction) in an area of the display panel 210. The display panel 210 of the example 402 may display an image over the entire area. The defect 420 may be formed over the entire area.

Referring to the example 403, defects 431, 432, and 433 may be formed on the display panel 210 of the electronic device 101. For example, the defects 431, 432, and 433 may be formed in a vertical direction (e.g., in a y-axis direction) in an area of the display panel 210. The display panel 210 of the example 403 may display an image over the entire area in the same manner as the example 402. The defects 431, 432, and 433 may be formed over the entire area.

Referring to FIG. 4, the defect formed on the display panel 210 may be formed in a vertical direction with respect to the display panel 210 regardless of a pattern of the image displayed via the display panel 210. The defect in the vertical direction may occur by electrical damage in a channel circuit in the source driver 352 of the display driving circuit 230. For example, it may be caused by damage to an amplifier (or a transistor of an amplifier) included in the channel circuit in the source driver 352. The transistor may be referred to as an output transistor of the amplifier.

Hereinafter, a device and a method for changing a channel circuit according to an embodiment of the present disclosure may identify (or sense) whether damage occurred in the channel circuit by measuring a voltage of a signal outputted from the channel circuit and comparing the measured voltage with a reference voltage for the channel circuit connected to the sub-pixel of the display panel. The device and the method for changing the channel circuit according to an embodiment of the present disclosure may disconnect a connection between the damaged channel circuit and the sub-pixel and connect (or repair) another channel circuit and the sub-pixel. Accordingly, the device and the method for changing the channel circuit according to an embodiment of the present disclosure, may reduce a defect rate that may occur in a process of producing and manufacturing an electronic device. Also, the device and the method for changing the channel circuit according to an embodiment of the present disclosure may improve the defect displayed via the display even when damage occurs during the process of using the electronic device.

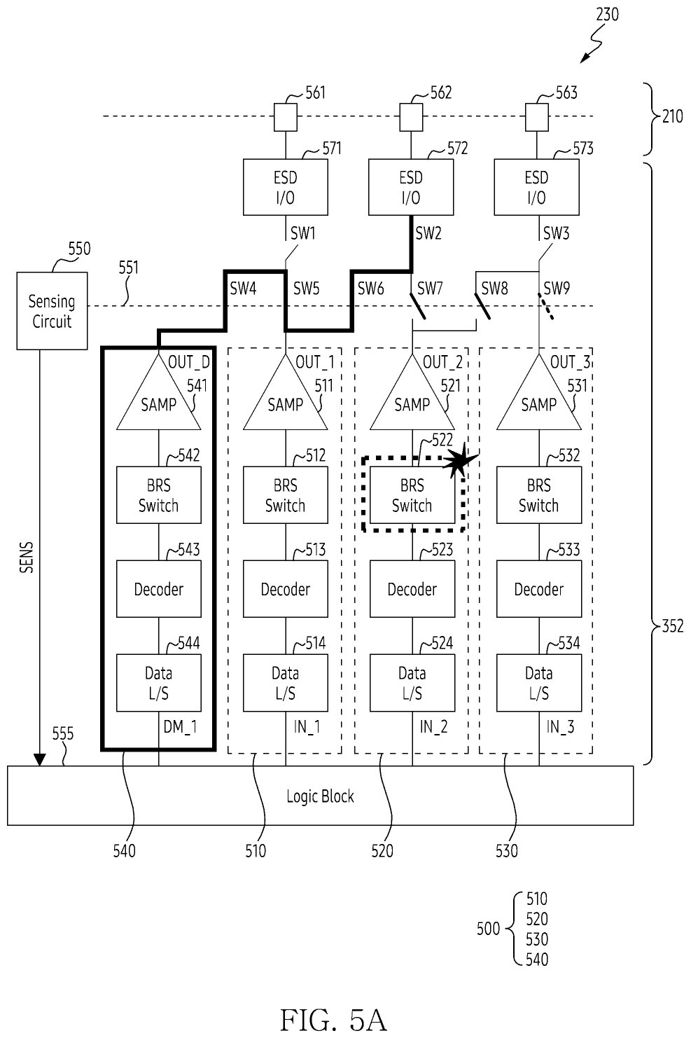

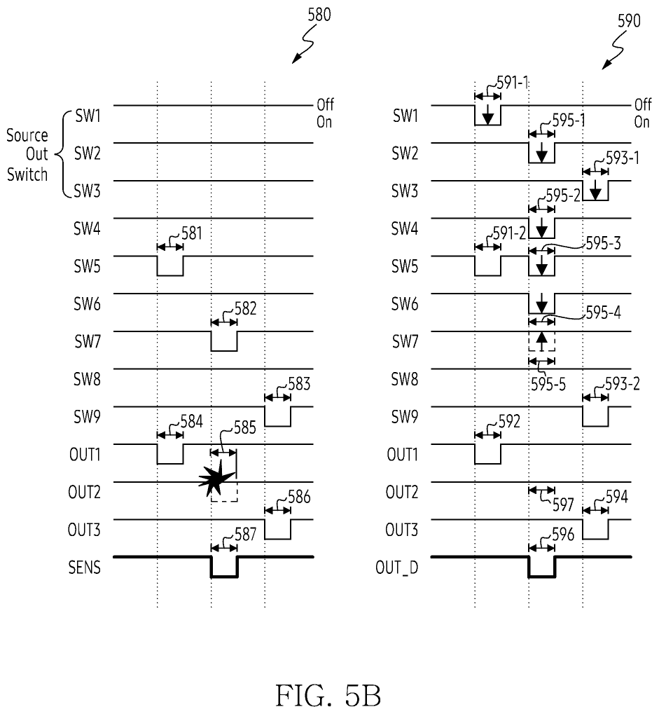

FIG. 5A illustrates an example of a display driving circuit including a channel circuit set. The display driving circuit may be understood substantially the same as the display driving circuit 230 of FIG. 2. The display driving circuit may be referred to as a control unit.

Referring to FIG. 5A, the display driving circuit 230 may include a display panel 210, a source driver 352, and a logic block 555. For example, the display panel 210 may include a structure for visually representing an image on the outside of an electronic device 101. For example, the display panel 210 may include output pads 561, 562, and 563. For example, the output pads 561, 562, and 563 may correspond to a plurality of sub-pixels included in the display panel 210. For example, the logic block 555 may indicate at least one component of the display driving circuit 230 for processing data transmitted to a channel circuit set 500 in the source driver 352. Also, the logic block 555 may obtain sensing information on signals outputted from the channel circuit set 500 from a sensing circuit 550. For example, the logic block 555 may control the source driver 352 based on the obtained sensing information.

For example, the source driver 352 may include the channel circuit set 500, the sensing circuit 550, and input/output ports 571, 572, and 573 (e.g., ESD I/O). For example, the channel circuit set 500 may include a plurality of channel circuits 510, 520, 530, and 540. For example, the channel circuit set 500 may include the channel circuits 510, 520, and 530 corresponding to the input/output ports 571, 572, and 573. For example, the channel circuit 510 may be connected to the output pad 561 via the input port 571. The channel circuit 520 may be connected to the output pad 562 via the input port 572. The channel circuit 530 may be connected to the output pad 563 via the input port 573. Being connected to the output pad may be understood in substantially the same manner as the channel circuit connected to the sub-pixel. For example, the channel circuit set 500 may include the channel circuit 540 that does not correspond to the input/output ports 571, 572, and 573. For example, the channel circuit 540 may indicate a spare channel circuit that is not connected to the input/output port and the output pad. The channel circuit 540 may be referred to as a dummy channel circuit. In FIG. 5A, the channel circuit set 500 including one channel circuit 540 and three channel circuits 510, 520, and 530 connected to the input/output port is illustrated, but an embodiment of the present disclosure is not limited thereto. For example, the channel circuit set 500 may include a plurality of dummy channel circuits. For example, the channel circuit set 500 may include channel circuits connected to four or more input/output ports.

For example, the channel circuit in the channel circuit set 500 may include various components. For example, the channel circuit 510 may include a level shifter (L/S) 514 (or data L/S), a decoder 513, a switch 512, and an amplifier 511 (or a source amplifier). For example, the channel circuit 520 may include a level shifter 524, a decoder 523, a switch 522, and an amplifier 521. For example, the channel circuit 530 may include a level shifter 534, a decoder 533, a switch 532, and an amplifier 531. For example, the channel circuit 540 may include a level shifter 544, a decoder 543, a switch 542, and an amplifier 541.

For example, the sensing circuit 550 may include a comparator. The comparator may compare a voltage of a signal detected by the sensing circuit 550 to a reference voltage. For example, the reference voltage may be set differently according to a gradation. For example, the reference voltage may be included in a reference voltage set including a plurality of reference voltages. For example, the sensing circuit 550 may be connected to an output terminal of a plurality of channel circuits 510, 520, 530, and 540. For example, the sensing circuit 550 may detect a voltage of a signal outputted from each of the plurality of channel circuits 510, 520, 530, and 540 via a sensing line 551. The output terminal may include an output terminal of an amplifier included in the channel circuit. For example, the sensing circuit 550 may transmit information (e.g., a signal voltage and a comparison result between the signal voltage and the reference voltage) on the detected signal to the logic block 555. Accordingly, the display driving circuit 230 may identify whether a defect occurred in a specific channel circuit based on the information on the signal. For example, the logic block 555 may identify whether a defect occurred in the specific channel circuit, based on the information on the signal.

For example, the input/output ports 571, 572, and 573 may be connected to corresponding channel circuits 510, 520 and 530 and corresponding output pads 561, 562, and 563. For example, the input/output port 571 may be connected to the channel circuit 510 via at least one switch (e.g., SW1 and/or SW5), and may be connected to the output pad 561. Also, the input/output port 572 may be connected to the channel circuit 520 via at least one switch SW2 and SW7 and may be connected to the output pad 562. Also, the input/output port 573 may be connected to the channel circuit 530 via at least one switch SW3 and SW9, and may be connected to the output pad 563. For example, each of the input/output ports 571, 572, and 573 may be connected to the channel circuit 540, which is the dummy channel circuit. For example, the input/output port 571 may be connected to the channel circuit 540 via at least one switch SW1 and SW4. Also, the input/output port 572 may be connected to the channel circuit 540 via at least one switch SW2, SW6, SW5, and SW4. Also, the input/output port 573 may be connected to the channel circuit 540 via at least one switch SW3, SW8, SW7, SW6, SW5, and SW4.

In the example of FIG. 5A, in a case that a defect occurs in the switch 522 of the channel circuit 520, the sensing circuit 550 may identify a voltage of a signal outputted from the channel circuit 520. The sensing circuit 550 may identify that the voltage of the signal is different from the reference voltage via the comparator included in the sensing circuit 550. The sensing circuit 550 may transmit information identified based on the comparator to the logic block 555. Based on the information, the logic block 555 (or the display driving circuit 230) may identify that the voltage of the signal outputted from the channel circuit 520 is different from the reference voltage, and may identify that a defect occurred in the channel circuit 520. Accordingly, the logic block 555 (or the display driving circuit 230) may change the channel circuit connected to the input/output port 572 and the output pad 562 (or the sub-pixel) to the channel circuit 540 in response to the defect identified in the channel circuit 520. In FIG. 5A, it is illustrated that a defect occurs in the switch 522, but an embodiment of the present disclosure is not limited thereto. For example, a case where a defect occurs in at least a portion of a component in the channel circuit (e.g., a defect in an amplifier) may also be included in the embodiment of the present disclosure.

Referring to the above, the display driving circuit 230 may perform identifying (or sensing) that a defect occurs in the channel circuit in the source driver 352 and changing (or recovering) the channel circuit in response to the defect. Specific details related to this will be described in FIG. 5B below.

FIG. 5B illustrates an example of a timing diagram for sensing and repairing operations of a display driving circuit including a channel circuit set. The sensing may indicate identifying a defect occurring in the channel circuit. The repairing may indicate disconnecting a sub-pixel connected to the channel circuit in which the defect is identified from the channel circuit and connecting it to another channel circuit. The display driving circuit of FIG. 5B may be understood in substantially the same manner as the display driving circuit 230 of FIG. 5A. For example, the channel circuit set of FIG. 5B may be understood to be substantially the same manner as the channel circuit set 500 of FIG. 5A.

FIG. 5B illustrates a timing diagram 580 indicating a sensing operation in which the display driving circuit 230 identifies the defect occurred in the channel circuit and a timing diagram 590 indicating a repairing operation of disconnecting the connection to the channel circuit and connecting to another channel circuit to the sub-pixel connected to the channel circuit. A SW1, a SW2, a SW3, a SW4, a SW5, a SW6, a SW7, a SW8, a SW9, an OUT1, an OUT2, an OUT3, a SENS, and an OUT_D displayed in the timing diagram 580 and the timing diagram 590 of FIG. 5B may be understood in the same manner as the SW1, the SW2, the SW3, the SW4, the SW5, SW6, the SW7, the SW8, the SW9, an OUT1, an OUT2, an OUT3, a SENS, and an OUT_D of FIG. 5A.

In the timing diagram 580 and the timing diagram 590, a case that each of the SW1, the SW2, the SW3, the SW4, the SW5, SW6, the SW7, the SW8, and the SW9 is in a high state may indicate a state in which the switch is turned off, and a case that each of the SW1, the SW2, the SW3, the SW4, the SW5, SW6, the SW7, the SW8, and the SW9 is in a low state may indicate a state in which the switch is turned on. Also, within the timing diagram 580 and the timing diagram 590, a case that each of OUT1, OUT2, and OUT3 is high may indicate a state in which the outputted signal does not exist, and a case that each of OUT1, OUT2, and OUT3 is low may indicate a state in which the outputted signal exists. Also, in the timing diagram 580 and the timing diagram 590, the SENS may indicate identification of a defective channel circuit based on a signal detected by the sensing circuit 550 via the sensing line 551. For example, a state in which the SENS is high may indicate that there is no defect, and a state in which the SENS is low may indicate that there is a defect. The display method (e.g., a result according to a high state, a result according to a low state) of the timing diagram 580 and the timing diagram 590 is only for convenience of a description, and embodiments of the present disclosure will not be limitedly interpreted thereto.

Referring to the timing diagram 580, for the sensing operation, SW1, SW2, and SW3 may be maintained in an off state. For example, SW1, SW2, and SW3 may be switches for connecting the channel circuit and the input/output port. For example, SW4, SW6, and SW8 may also be maintained in the off state while the sensing operation is performed. For example, SW4 may be a switch for connecting a dummy channel circuit (e.g., the channel circuit 540) to input/output ports. SW6 may be a switch for connecting the channel circuit 510 and the channel circuit 520. SW8 may be a switch for connecting the channel circuit 520 and the channel circuit 530.

For example, SW5 may be changed to an on state in a time interval 581. Accordingly, OUT1 may indicate that an output exists (on) in a time interval 584 corresponding to the time interval 581. For example, SW9 may be changed to the on state in a time interval 583. Accordingly, OUT3 may indicate that an output exists (on) in a time interval 586 corresponding to the time interval 583. Alternatively, SW7 may be changed to the on state in a time interval 582. OUT2 may indicate that no output exists (off) in a time interval 585 corresponding to the time interval 582. Accordingly, the SENS may indicate that there is (on) a defect in a time interval 587 corresponding to the time interval 585.

Related to the timing diagram 580, referring to FIG. 5A, each of the channel circuits 510, 520, and 530 may output data transmitted from the logic block 550. In this case, in a case that the SW5, the SW7, and the SW9 are turned on in a specific time interval, the sensing result for each of OUT1 corresponding to the SW5, OUT2 corresponding to the SW7, and OUT3 corresponding to the SW9 may be expected to indicate that the outputted signal exists (on). However, in a case that a defect occurs in the switch 522 of the channel circuit 520, as in the example of FIG. 5A, the OUT2 may be identified as having no output. In other words, such as the timing diagram 580, the OUT2 may indicate that the output does not exist (off) even when the SW7 is changed to on.

Referring to the timing diagram 590, a state of the switch may be changed according to a interval in which a signal is outputted from the channel circuit. In the example of FIG. 5A, in the time interval outputted by the channel circuit 510, the SW1 and the SW5 may be changed to the on state. For example, the SW1 may be changed to the on state in a time interval 591-1, and the SW5 may be changed to the on state in a time interval 591-2. Accordingly, the OUT1 may indicate that an output exists (on) in a time interval 592 corresponding to the time interval 591-1 and the time interval 591-2. Also, in the time interval outputted by the channel circuit 530, the SW3 and the SW9 may be changed to the on state. For example, the SW3 may be changed to the on state in a time interval 593-1, and the SW9 may be changed to the on state in a time interval 593-2. Accordingly, the OUT3 may indicate that an output exists (on) in a time interval 594 corresponding to the time interval 593-1 and the time interval 593-2.

In contrast, in the case of a defective channel circuit, a state of a switch related to the defective channel circuit may be changed for a repairing operation. In the example of FIG. 5A, since the defect occurred in the switch 522 of the channel circuit 520, a connection between the input/output port 572 and the output pad 562 (or the sub-pixel) connected to the channel circuit 520 and the channel circuit 520 may be disconnected. For example, the SW7 may be maintained in the off state in a time interval 595-5. Also, the channel circuit 540 may be connected to the input/output port 572 and the output pad 562, according to identifying a defect in the channel circuit 520. For example, the SW4 may change to the on state in a time interval 595-2, the SW5 may change to the on state in a time interval 595-3, and the SW6 may change to the on state in a time interval 595-4. Accordingly, the OUT2 corresponding to the channel circuit 520 may indicate that no output exists (off) in a time interval 597 corresponding to the time intervals 595-1, 595-2, 595-3, 595-4, and 595-5. The OUT_D corresponding to the channel circuit 540 may indicate that an output exists (on) in a time interval 596 corresponding to the time intervals 595-1, 595-2, 595-3, 595-4, and 595-5. In other words, in the time interval 595-1 in which a signal is scheduled to be outputted via the channel circuit 520, the SW2 related to the input/output port 572 and the output pad 562 may be changed to the on state. In this case, the signal outputted from the channel circuit 520 does not exist (e.g., the OUT2 of the time interval 597), and only the signal outputted from the channel circuit 540 which is a changed channel circuit may exist (e.g., the OUT_D of the time interval 596). For example, the channel circuit 540 may replace the channel circuit 520.

According to the timing diagram 590, the display panel 210 may be identified as performing a normal operation outside the electronic device 101. For example, a case is assumed that the display panel 210 operates in an order of the input/output port 571 and the output pad 561, the input/output port 572 and the output pad 562, and the input/output port 573 and the output pad 563. Such as the example of FIG. 5A, in a case that a defect is identified in the channel circuit 520 connected to the input/output port 572 and the output pad 562, a connection between the input/output port 572 and the output pad 562 to the channel circuit 520 may be disconnected. Also, the input/output port 572 and the output pad 562 may be connected to the channel circuit 540. Accordingly, switches related to the channel circuit 510, the channel circuit 540, and the channel circuit 530 may be changed to the on state in each time interval in which the SW1 for the input/output port 571 and the output pad 561, the SW2 for the input/output port 572 and the output pad 562, and the SW3 for the input/output port 573 and the output pad 563 are changed to on.

In FIGS. 5A and 5B, a case in which a channel circuit is connected to an input/output port and an output pad is described as an example, but the input/output port and the output pad may correspond to the sub-pixel of the display panel. For example, the channel circuit may be connected to or disconnected from the sub-pixel. Also, in FIGS. 5A and 5B, an output is classified as being exist or not, but the embodiment of the present disclosure is not limited thereto. As described above, indicating that the output of FIG. 5B exists may be understood in substantially the same manner as indicating that a result of comparing a voltage of a signal outputted from the channel circuit with a reference voltage is the same. Also, indicating that the output of FIG. 5B does not exist may be understood in substantially the same manner as indicating that a result of comparing a voltage of a signal outputted from the channel circuit with the reference voltage is different.

FIG. 6A is a flowchart illustrating an example of a method of changing a channel circuit of a source driver connected to a display panel. The method may be performed by a display driving circuit 230. For example, at least a portion of operations included in the method may be controlled by the display driving circuit 230. The display driving circuit 230 may be referred to as a control circuit. Meaning of a connection between the display panel and the channel circuit may indicate that a sub-pixel of the display panel is connected to the channel circuit. The sub-pixel may correspond to an output pad (e.g., the output pad 561 of FIG. 5A) connected to an input/output port (e.g., the input/output port 571 of FIG. 5A).

Referring to FIG. 6A, in an operation 600, the display driving circuit 230 may identify an event for changing a state of a display panel 210. For example, the display driving circuit 230 may identify an event for changing the state of the display panel 210 from a first state to a second state. For example, the first state may indicate a state that the display panel 210 is turned off. The second state may indicate a state that the display panel 210 is turned on. The event may include a gesture, a touch input, or an input for a button exposed to an outside of the electronic device for changing the first state to the second state. For example, the display driving circuit 230 may identify the event received from a processor 120 in response to identifying the gesture or the touch input based on a sensor (e.g., the sensor module 176, or the touch sensor 251). For example, the display driving circuit 230 may identify the event by receiving information on the input to the button identified by the processor 120.

In an operation 605, the display driving circuit 230 may respectively identify signals outputted via the plurality of channel circuits in the first state. For example, the display driving circuit 230 may respectively identify the signals outputted via the plurality of channel circuits via a sensing circuit (e.g., the sensing circuit 550 of FIG. 5A). For example, the plurality of channel circuits may be included in a channel circuit set. The plurality of channel circuits may indicate different channel circuits from a dummy channel circuit included in the channel circuit set. For example, the plurality of channel circuits may be connected to the plurality of sub-pixels included in the display panel 210. For example, the signals may include a data voltage for sub-pixels.

For example, the display driving circuit 230 may measure a voltage of each of the signals via the sensing circuit. The display driving circuit 230 may compare the voltage of each of the signals to a reference voltage based on the sensing circuit. For example, the display driving circuit 230 may measure the voltage of each of the signals outputted from the plurality of channel circuits in a partial time interval from among a plurality of partial time intervals (e.g., a horizontal synchronization signal (Hsync) time interval) included in a time interval (e.g., a vertical synchronization signal (Vsync) time interval). For example, the display driving circuit 230 may measure the voltage of each of the other signals outputted from the plurality of channel circuits in a partial time interval subsequent to the partial time interval from among the plurality of partial time intervals. As described above, the display driving circuit 230 may measure a voltage of signals for all of the plurality of channel circuits via the sensing circuit every partial time period. For example, the display driving circuit 230 may compare the voltage of the signals to the reference voltage based on the sensing circuit. The reference voltage may be included in a reference voltage set including a plurality of reference voltages. The plurality of reference voltages may be identified based on a gradation implementable via the sub-pixel. For example, the plurality of reference voltages may correspond to 256 gradations.

In an operation 610, the display driving circuit 230 may disconnect the channel circuit outputting a signal having a voltage different from the reference voltage from among the plurality of channel circuits from the sub-pixel, and connect the sub-pixel to another channel circuit in the first state. For example, the display driving circuit 230 may identify whether the voltage of each of the signals outputted by the plurality of channel circuits corresponds to the reference voltage in the first state. For example, the display driving circuit 230 may identify whether the voltage and the reference voltage correspond based on the sensing circuit in the first state. In a case that the signal having the voltage different from the reference voltage is identified, the display driving circuit 230 may identify the channel circuit outputting the signal. For example, the display driving circuit 230 may generate a flag for indicating the channel circuit outputting the signal.

For example, the display driving circuit 230 may disconnect a connection between the sub-pixel connected to the channel circuit and the channel circuit in response to identifying the channel circuit outputting the signal. For example, the display driving circuit 230 may connect the sub-pixel and the another channel circuit. Disconnecting the connection between the sub-pixel and the channel circuit, and performing (or a repairing operation) the connection between the sub-pixel and the another channel circuit may be performed based on the flag.

For example, the repairing operation may be performed in a time interval (e.g., the vertical synchronization signal (Vsync) time interval) different from a sensing operation comparing between the reference voltage and the voltage. For example, the sensing operation may be performed in a first time interval. The repairing operation may be performed in a second time interval subsequent to the first time interval. The another channel circuit may indicate the dummy channel circuit (e.g., the channel circuit 540 of FIG. 5A) included in the channel circuit set. The connection may include forming a path between the channel circuit and the sub-pixel by changing a state of a switch between the channel circuit and the sub-pixel (or, an input/output port and an output pad for connecting to the sub-pixel).

In an operation 615, the display driving circuit 230 may display an image based on the plurality of channel circuits including the another channel circuit in the second state. For example, the display driving circuit 230 may output signals via the plurality of channel circuits, including the another channel circuit in the second state. Each of the signals may be outputted from a corresponding channel circuit and applied to a corresponding sub-pixel. Accordingly, the display driving circuit 230 may display the image via the display panel 210.

FIG. 6B is a flowchart illustrating an example of a method of sequentially sensing a voltage of channel circuits in a source driver. The method may be performed by the display driving circuit 230. For example, at least a portion of operations included in the method may be controlled by the display driving circuit 230. The display driving circuit 230 may be referred to as a control circuit. The meaning of a connection between the display panel and the channel circuit may indicate that a sub-pixel of the display panel is connected to the channel circuit. The sub-pixel may correspond to an output pad (e.g., the output pad 561) connected to an input/output port (e.g., the input/output port 571). The method of FIG. 6B may include detailed operations of the operation 605 of FIG. 6A.

In an operation 650, the display driving circuit 230 may identify a first set of signals in the first partial time interval from among the plurality of partial time intervals in the first time interval. For example, the display driving circuit 230 may identify the first set of signals outputted from the plurality of channel circuits in the first partial time interval of the first time interval indicating the vertical synchronization signal time interval (V time interval). For example, the display driving circuit 230 may identify the first set of signals of the plurality of channel circuits via the sensing circuit (e.g., the sensing circuit 550) included in a source driver 352 of the display driving circuit 230.

For example, the first time interval may be triggered in response to the event for changing the state of the display panel 210 from the first state to the second state. For example, the plurality of partial time intervals may be related to resolution of the display panel 210. For example, in the case of the display panel 210 supporting 1080*2400 resolution, the plurality of partial time intervals (or the horizontal synchronization signal time intervals (H time intervals) may be implemented with 2400 time intervals. This is because the time interval is time for outputting once via an entire area of the display panel 210. Hereinafter, in the present disclosure, for convenience of a description, the case where the resolution supported by the display panel 210 is 1080*2400 (width*length) will be described as an example, but an embodiment of the present disclosure is not limited thereto.

For example, the display driving circuit 230 may receive a command for changing the state of the display panel 210, which is transmitted by the processor 120 in response to identifying the event. For example, the first time interval may be triggered based on the command. For example, in response to receiving the command, the display driving circuit 230 may transmit a signal to the display panel 210 for changing the state of the display panel 210 from the first state to the second state.

In an operation 655, the display driving circuit 230 may sequentially compare the first set of signals to a first reference voltage in the first partial time interval. For example, the display driving circuit 230 may sequentially compare the first set of signals outputted from the plurality of channel circuits to the first reference voltage based on the sensing circuit. For example, after comparing a signal outputted from a first channel circuit included in the plurality of channel circuits to the first reference voltage, a signal outputted from a second channel circuit included in the plurality of channel circuits may be compared with the first reference voltage. A comparison of the first channel circuit and the second channel circuit may be sequentially performed in the first partial time interval. For example, the number of the plurality of channel circuits may correspond to the number of the plurality of sub-pixels included in the display panel 210. For example, in a case that the display panel supports 1080*2400 (width*length) resolution, the number of the plurality of channel circuits may be 1080, which is the number of pixels in a direction (horizontal) to which the source driver applies the data voltage. In this case, according to a configuration (e.g., RGB includes 3 sub-pixels, RGBG includes 4 sub-pixels) of the pixel, the number of a plurality of sub-pixels may be 1080*3 or 1080*4, and the number of the plurality of channel circuits may also be 1080*3 or 1080*4.

In an operation 660, the display driving circuit 230 may identify a second set of signals in a second partial time interval from among the plurality of partial time intervals in the first time interval. For example, the display driving circuit 230 may identify the second set of signals outputted from the plurality of channel circuits in the second partial time interval subsequent to the first partial time interval of the first time interval indicating the vertical synchronization signal time interval. For example, the display driving circuit 230 may identify the second set of signals of the plurality of channel circuits via the sensing circuit (e.g., the sensing circuit 550) included in the source driver 352 of the display driving circuit 230.

In an operation 665, the display driving circuit 230 may sequentially compare the second set of signals to a second reference voltage in the second partial time interval. For example, the display driving circuit 230 may sequentially compare the second set of signals outputted from the plurality of channel circuits to the second reference voltage based on the sensing circuit. For example, after comparing the signal outputted from the first channel circuit included in the plurality of channel circuits to the second reference voltage, a signal outputted from the second channel circuit included in the plurality of channel circuits, and the second reference voltage may be compared. The comparison between the first channel circuit and the second channel circuit may be sequentially performed in the second partial time interval.

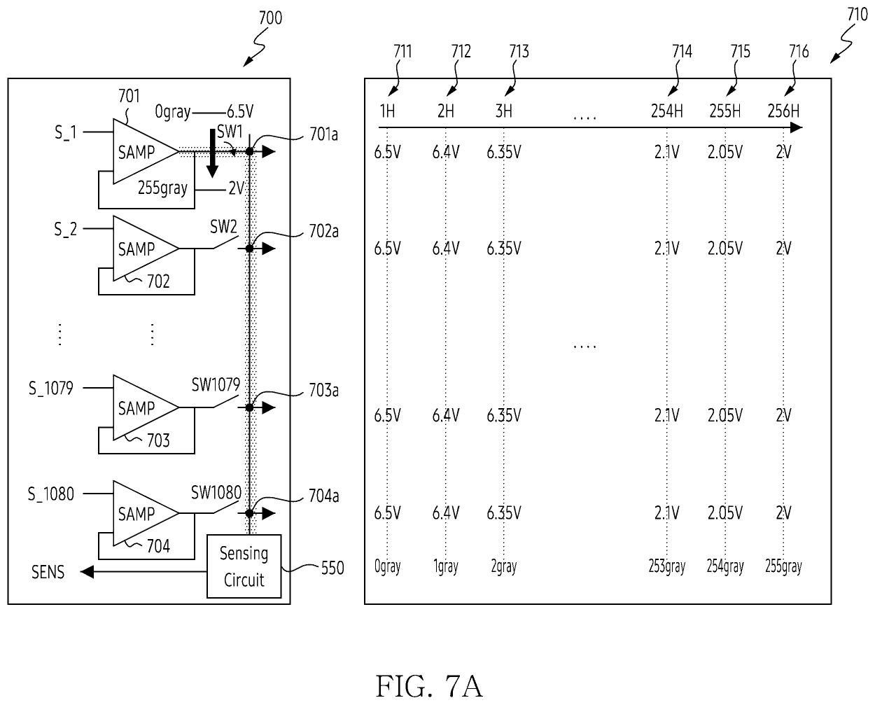

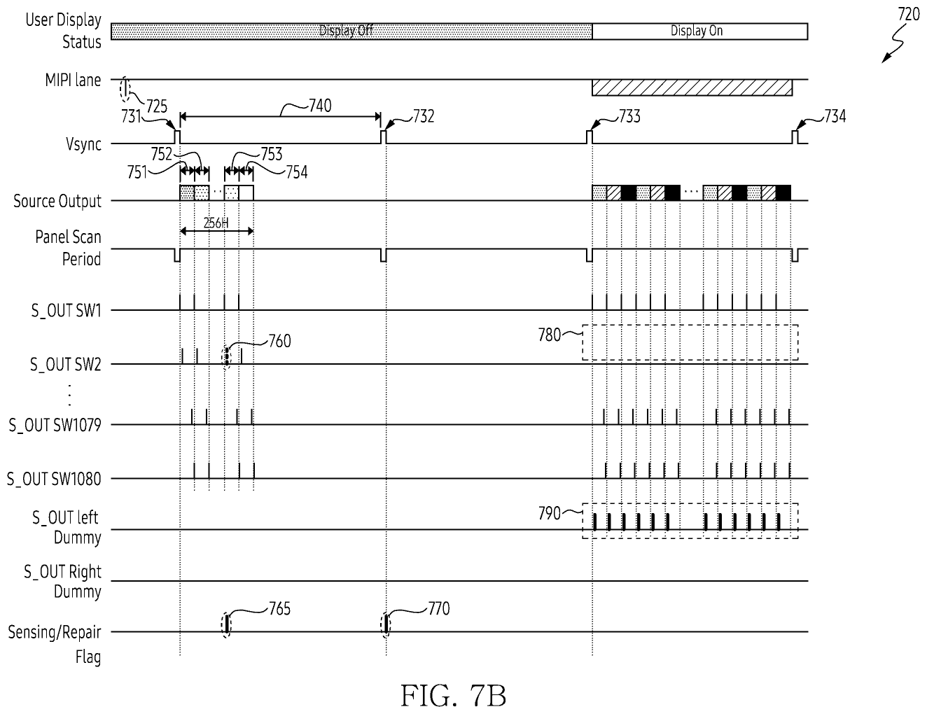

In FIG. 6B, specific details of an operation of sequentially comparing and sensing each voltage of signals outputted from the plurality of channel circuits and the reference voltage, and an operation of changing the voltage and the reference voltage according to the gradation will be described in FIG. 7A below.

FIG. 7A illustrates an example of a method of sequentially sensing a voltage of channel circuits in a source driver. The method may be performed by a display driving circuit 230. For example, the method may be controlled by the display driving circuit 230. The display driving circuit 230 may be referred to as a control circuit.

Referring to FIG. 7A, an example 700 indicating a structure of sequentially sensing the voltage of channel circuits in a source driver 352 and an example 710 indicating a method of sensing a signal outputted with a different magnitude of voltage over time are illustrated.

Referring to the example 700, the source driver 352 may include a plurality of amplifiers 701, 702, 703, and 704 and a sensing circuit 550. For example, the source driver 352 of the example 700 may include 1080 amplifiers (e.g., amplifiers 701, 702, 703, and 704). The amplifier 701 may indicate a first amplifier, the amplifier 702 may indicate a second amplifier, the amplifier 703 may indicate a 1079th amplifier, and the amplifier 704 may indicate a 1080th amplifier. However, an embodiment of the present disclosure is not limited thereto, and may vary according to resolution of a display panel 210 and a structure of a pixel. For example, in the case of the display panel 210 supporting a pixel structure of RGB and 1080*2400 (width*length) resolution, the source driver 352 may include 3240 amplifiers. For example, in the case of the display panel 210 supporting a pixel structure of RGBG and 1080*2400 (width*length) resolution, the source driver 352 may include 4320 amplifiers. Although only the amplifier is illustrated in the example 700 for convenience of a description, it may be understood that the amplifier of the example 700 corresponds to a channel circuit in the source driver 352.

Referring to the example 700, the sensing circuit 550 may be connected to the amplifiers 701, 702, 703, and 704 (or the channel circuits). For example, the sensing circuit 550 may be connected to a point of an output terminal of the amplifiers 701, 702, 703, and 704. For example, the sensing circuit 550 may be connected to the amplifier 701 at a point 701a of the output terminal of the amplifier 701. The sensing circuit 550 may be connected to the amplifier 702 at a point 702a of the output terminal of the amplifier 702. The sensing circuit 550 may be connected to the amplifier 703 at a point 703a of the output terminal of the amplifier 703. The sensing circuit 550 may be connected to the amplifier 704 at a point 704a of the output terminal of the amplifier 704. For example, a switch may be positioned between the sensing circuit 550 and the point where each of the amplifiers 701, 702, 703, and 704 are connected. For example, an area between the sensing circuit 550 and the amplifier 701 may include a switch SW1. An area between the sensing circuit 550 and the amplifier 702 may include a switch SW2. An area between the sensing circuit 550 and the amplifier 703 may include a switch SW1079. An area between the sensing circuit 550 and the amplifier 704 may include a switch SW1080. A connection state between the channel circuit corresponding to the amplifier and the sub-pixel may be changed based on the switch.

The example 710 illustrates an example in which the sensing circuit 550 senses a voltage of the signal outputted from the amplifiers 701, 702, 703, and 704 of the example 700 over time. Each of time intervals 711, 712, 713, 714, 715, and 716 of the example 710 may indicate horizontal synchronization signal (Hsync) time interval. Hereinafter, each of the time intervals 711, 712, 713, 714, 715, and 716 may be referred to as H time interval. The time intervals 711, 712, 713, 714, 715, and 716 may be included in a vertical synchronization signal (Vsync) time interval. Hereinafter, the vertical synchronization signal time interval may be referred to as V time interval. For example, a vertical synchronization signal time interval may include a plurality of horizontal synchronization signal time intervals based on resolution of the display panel 210. For example, in the case of the display panel 210 supporting 1080*2400 resolution, a vertical synchronization signal time interval may include 2400 horizontal synchronization signal time intervals.

Referring to the example 710, the 256 H time intervals 711, 712, 713, 714, 715, and 716 may be identified according to the number of gradations that a sub-pixel (or the channel circuit connected to the sub-pixel) may represent. In other words, in the example 710, the number of gradations that the sub-pixel (or the channel circuit) may represent may be 256. For example, a gradation with an index of 0 (0 gray) may indicate the darkest color, and a gradation with an index of 255 (255 gray) may indicate the brightest color. In order to indicate each gradation, a magnitude of a voltage of the signal outputted by the source driver 352 via the amplifiers 701, 702, 703, and 704 may be set in advance. For example, the gradation with the index of 0 may be set to approximately 6.5V, a gradation with the index of 1 may be set to approximately 6.4V, a gradation with the index of 2 may be set to approximately 6.35V, a gradation with the index of 253 may be set to approximately 2.1V, a gradation with the index of 254 may be set to approximately 2.05V, and the gradation with the index of 255 may be set to approximately 2V. The above-described examples are merely examples for convenience of a description, and embodiments of the present disclosure are not limitedly interpreted.

Referring to the examples 700 and 710, the sensing circuit 550 may respectively identify signals outputted via 1080 amplifiers 701, 702, 703, and 704 in 256 H time intervals 711, 712, 713, 714, 715, and 716. For example, in a first H time interval 711, the sensing circuit 550 may identify a signal (or a voltage of a signal) outputted from the first amplifier 701 as the switch SW1 is changed to on. In the first H time interval 711, the sensing circuit 550 may identify a signal outputted from the second amplifier 702 as the switch SW2 is changed to on after identifying the signal of the first amplifier 701. In the sequential manner as described above, the sensing circuit 550 may identify a signal outputted from each of the first amplifier 701 to the 1080th amplifier 704 in the first H time interval 711. For example, the sensing circuit 550 may identify (or compare) whether the voltage of the signal outputted from each of the first amplifier 701 to the 1080th amplifier 704 corresponds to approximately 6.5V. For example, a switch changed to the on state may be changed back to the off state when the sensing circuit 550 identifies a signal, or immediately before the first H time interval 711 ends.

For example, in a second H time interval 712 subsequent to the first H time interval 711, the sensing circuit 550 may identify a signal (or a voltage of a signal) outputted from the first amplifier 701 as the switch SW1 is changed back to on. In the second H time interval 712, the sensing circuit 550 may identify a signal outputted from the second amplifier 702 as the switch SW2 is changed back to on after identifying the signal of the first amplifier 701. In the sequential manner as described above, the sensing circuit 550 may identify a signal outputted from each of the first amplifier 701 to the 1080th amplifier 704 in the second H time interval 712. For example, the sensing circuit 550 may identify (or compare) whether the voltage of the signal outputted from each of the first amplifier 701 to the 1080th amplifier 704 corresponds to approximately 6.4V. Similar to the above, the sensing circuit 550 may sequentially identify each of the signals outputted from 1080 amplifiers 701, 702, 703, and 704 in the first H time interval 711 to the 256th H time interval 716.

For example, in a 1 H time interval (e.g., the first H time interval 711), a clock for outputting the signals outputted from the plurality of amplifiers 701, 702, 703, and 704 and sensing a signal of the signals outputted from the plurality of amplifiers 701, 702, 703, and 704 may be set for the source driver 352. For example, the clock rate may be set based on a period of a V time interval, a period of an H time interval, and the number of amplifiers (or channels) that are outputted and sensed in the H time interval. For example, assuming a 120 Hz scanning rate and 1080*2400 resolution, a V time interval may correspond to 1/120 [sec]. In this case, since a V time interval includes 2400 H time interval, a H time interval may correspond to (1/120)*(1/2400). Also, in a case that 1080 amplifiers are included, the time interval for each amplifier may correspond to (1/120)*(1/2400)*(1/1080) [sec]. Therefore, the clock rate capable of supporting the time interval (1/120)*(1/2400)*(1/1080) may be set. The example of FIG. 7A is merely for convenience of a description, and embodiments of the present invention are not limitedly interpreted to the example of FIG. 7A.

FIG. 7B illustrates an example of a timing diagram for an operation of outputting an image by changing a channel circuit connected to a display panel of a source driver.

A timing diagram 720 of FIG. 7B illustrates an example indicating a signal transmission flow and an image output between the processor 120, the display driving circuit 230, and the display panel 210.

In the timing diagram 720, for example, a user display status may indicate a state of the display panel 210. For example, the display off may indicate a first state that the display panel 210 is turned off. The display on may indicate a second state that the display panel 210 is turned on.

For example, a mobile industry processor interface (MIPI) may indicate a transmission state of a command, data, and a signal transmitted from the processor 120 to the display driving circuit 230.

For example, the Vsync may indicate a vertical synchronization signal. The H (Hsync) in the Vsync may indicate a horizontal synchronization signal. In the example of FIG. 7B, in a case of the display panel 210 supporting 1080*2400 resolution, a 1Vsync may include 2400 Hsyncs.

For example, a source output may indicate data (e.g., a gradation) of a signal outputted by the channel circuits of the source driver 352. For example, each of the 256 gradations may be outputted every 1 H (H time interval). For example, each of the 256 gradations may be outputted via a corresponding H time interval from among 256 H time intervals 751, 752, 753, and 754.

For example, a panel scan period may indicate a interval in which the sensing circuit 550 senses the signals outputted from the channel circuits of the source driver 352. For example, a high state of the panel scan period may indicate that a scan (or sensing) is performed, and a low state may indicate that a scan is not performed.

For example, each of channel circuit outputs S_OUT SW1, S_OUT SW2, . . . , S_OUT SW1079, and S_OUT SW1080 may indicate that in the high state, a signal is outputted, and in the low state, a signal is not outputted. In FIG. 7B, for convenience of a description, whether a defect occurred in the channel circuit is identified via whether the signal is outputted, but an embodiment of the present disclosure is not limited thereto. For example, even when the signal is outputted, in a case that a voltage of the outputted signal and a reference voltage are different, it may be understood that a defect occurred.

For example, each of dummy channel circuit outputs S_OUT Left dummy may indicate that in the high state, the signal is outputted, and in the low state, the signal is not outputted.

For example, a sensing and repairing flag may indicate a flag for indicating a channel circuit sensing a defect and indicating repairing the sensed channel circuit. For example, the high state of the sensing and repairing flag may indicate that a defect in a particular channel circuit is sensed and repaired.

Referring to the timing diagram 720, in the first state (display off) of the display panel 210, the display driving circuit 230 may receive a command 725 for changing the state of the display panel 210 to the second state (display on) from the processor 120 via the MIPI. The command 725 may be referred to as a command signal or a signal. For example, the processor 120 may transmit the command 725 to the display driving circuit 230 in response to identifying an event for an electronic device 101. For example, the event may include a gesture, a touch input, or an input for a button exposed to an outside of the electronic device for changing the first state to the second state.

For example, the display driving circuit 230 may trigger a first V time interval 740 at a first time 731 in response to receiving the command 725. In the example of the timing diagram 720, the first V time interval 740 may include 2400 H time intervals. For example, the display driving circuit 230 may periodically trigger the V time interval in each of times 731, 732, 733, and 734 based on the command 725.

For example, as the first V time interval 740 is triggered at the first time 731, the display driving circuit 230 may output a signal corresponding to each of the 256 gradations via the plurality of channel circuits of the source driver 352. For example, the display driving circuit 230 may output signals having a voltage corresponding to the gradation with the index of 0 via the plurality of channel circuits in the first H time interval 751. For example, the display driving circuit 230 may output signals having a voltage corresponding to a gradation with the index of 1 via the plurality of channel circuits in the second H time interval 752. For example, the display driving circuit 230 may output signals having a voltage corresponding to the gradation with the index of 254 via the plurality of channel circuits in the 255th H time interval 753. For example, the display driving circuit 230 may output signals having a voltage corresponding to a gradation with the index of 255 via the plurality of channel circuits in the 256th H time interval 754. The plurality of channel circuits may be included in a channel circuit set included in the source driver 352. The channel circuit set may include the plurality of channel circuits connected to the plurality of sub-pixels of the display panel 210 and at least one dummy channel circuit disconnected from the plurality of sub-pixels.

For example, the display driving circuit 230 may perform sensing (or scanning) during the first time interval 740 triggered at the first time 731. For example, the display driving circuit 230 may identify signals outputted from the plurality of channel circuits during the first V time interval 740 via the sensing circuit 550 connected to the channel circuit set. For example, in the first H time interval 751, the display driving circuit 230 may identify a signal with a voltage corresponding to the gradation with the index of 0 outputted from each of the first channel circuit S_OUT SW1 to the 1080th channel circuit S_OUT SW1080. For example, in the second H time interval 752, the display driving circuit 230 may identify a signal with a voltage corresponding to a gradation with an index of 1 outputted from each of the first channel circuit S_OUT SW1 to the 1080th channel circuit S_OUT SW1080. For example, the display driving circuit 230 may identify a signal with a voltage corresponding to the gradation with the index of 254 outputted from each of the first channel circuit S_OUT SW1 to the 1080th channel circuit S_OUT SW1080, in the 255th H time interval 753. For example, the display driving circuit 230 may identify a signal with a voltage corresponding to a gradation with the index of 255 outputted from each of the first channel circuit S_OUT SW1 to the 1080th channel circuit S_OUT SW1080, in the 256th H time interval 754. The identification may include the sensing circuit 550 detecting a signal from an output terminal of the channel circuit and comparing between the voltage of the detected signal and a reference voltage set for each gradation.

For example, the display driving circuit 230 may identify a defect for a specific channel circuit. For example, the display driving circuit 230 may identify that the voltage of the signal 760 outputted from the second channel circuit in the 255th H time interval 753 is different from the voltage (or the reference voltage) corresponding to the gradation with the index of 254. Accordingly, the display driving circuit 230 may identify a defect in the second channel circuit and generate a flag 765 for indicating the defect in the second channel circuit.

For example, the display driving circuit 230 may perform repairing the second channel circuit based on the flag 765 in response to the second V time interval being triggered at the second time 732. For example, the display driving circuit 230 may disconnect a sub-pixel corresponding to the second channel circuit from the second channel circuit. For example, the display driving circuit 230 may change a state of at least one switch to disconnect a connection between the second channel circuit and the sub-pixel. Also, the display driving circuit 230 may connect the sub-pixel and a dummy channel circuit. For example, the display driving circuit 230 may change a state of at least one switch for a connection between the dummy channel circuit and the sub-pixel. Accordingly, the display driving circuit 230 may generate a flag 770 for indicating that repairing for the second channel circuit was performed.

For example, the display driving circuit 230 may change the state of the display panel 210 to a second state (display on) at the third time 733. For example, the display driving circuit 230 may receive image data to be outputted via the display panel 210 from the processor 120 via the MIPI from the third time 733 when it is changed to the second state. For example, the display driving circuit 230 may output the image in a third V time interval triggered at the third time 733. Based on the data, the display driving circuit 230 may output the image via the plurality of channel circuits of the channel circuit set. For example, the display driving circuit 230 may output signals 790 via the dummy channel circuit instead of outputting signals 780 via the second channel circuit based on the flag 770. In other words, the plurality of channel circuits may include the dummy channel circuit instead of the second channel circuit. In FIG. 7B, it is illustrated that the repairing is performed in the second V time interval triggered in the second time 732, and an image is outputted in the third V time interval, which is the V time interval subsequent to the second V time interval, but an embodiment of the present disclosure is not limited thereto. For example, the display driving circuit 230 may perform the repairing and the output of the image together in the second V time interval triggered at the second time 732. Also, the display driving circuit 230 may output the image after performing the repairing in the second V time interval.

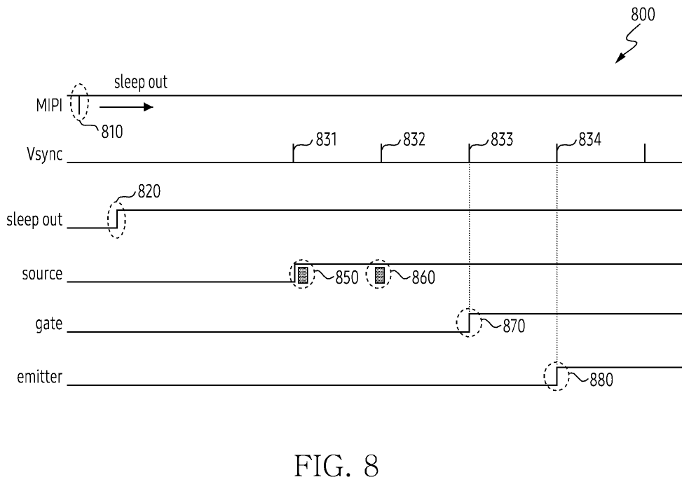

FIG. 8 illustrates an example of a timing diagram for a control circuit for outputting an image by changing a channel circuit connected to a display panel of a source driver.

A timing diagram 800 of FIG. 8 illustrates an example of a signal transmission flow and an image output between a processor 120, a display driving circuit 230, and a display panel 210.

In the timing diagram 800, for example, a mobile industry processor interface (MIPI) may indicate a transmission state of a command, data, and signal transmitted from the processor 120 to the display driving circuit 230.

For example, a Vsync may indicate a vertical synchronization signal. The Vsync may include a plurality of Hsyncs (Hs) (not illustrated). The Hysnc (H) may indicate a horizontal synchronization signal. In the example of FIG. 7B, 1Vsync may include 2400 Hsyncs in a case of the display panel 210 supporting 1080*2400 resolution. The Vsync may be triggered according to receiving a command 810 for changing the display driving circuit 230 to a driving state (sleep-out) from the MIPI.

For example, a source output may indicate data (e.g., a gradation) of a signal outputted by channel circuits of a source driver 352. For example, each of the 256 gradations may be outputted every 1 H (H time interval).

For example, a gate output may indicate a control signal for driving a gate of a transistor in the display panel 210 of a gate driver 353. For example, in a case that the gate output is in a high state, it may indicate that the control signal for turning on the state of the gate is outputted from the gate driver 353 to the display panel 210.

For example, an emitter output may indicate a light emitting signal of a light emitting driver 354. For example, in a case that the emitter output is in the high state, it may indicate that the light emitting signal is outputted from the light emitting driver 354 to the display panel 210.

Referring to the timing diagram 800, in a first state (display off) of the display panel 210, the display driving circuit 230 may receive a command 810 for changing the state of the display panel 210 to a second state (display on) from the processor 120 via the MIPI. The command 810 may be referred to as a command signal or a signal. For example, the processor 120 may transmit the command 810 to the display driving circuit 230 in response to identifying an event for an electronic device 101. For example, the event may include a gesture, a touch input, or an input for a button exposed to an outside of the electronic device for changing the first state to the second state.

For example, the display driving circuit 230 may be changed, at time 820, to a state of driving (sleep out) from a state of not driving (sleep) in response to the command 810. Although not illustrated in FIG. 8, at the time 820, the display panel 210 may be in a display off state.

For example, the display driving circuit 230 may be changed to the state of driving at time 820 and may generate periodic Vsync signals based on the command 810. For example, the display driving circuit 230 may generate the Vsync signal for a V time interval in each of times 831, 832, 833, and 834. The Vsync signal may indicate a signal for triggering the V time interval.

For example, the display driving circuit 230 may perform sensing 850 a plurality of channel circuits in the source driver 352 as the first V time interval is triggered at time 831. For example, the display driving circuit 230 may identify a voltage of a signal outputted from each of the plurality of channel circuits, and compare it to a reference voltage in a portion of the plurality of H time intervals (or partial time intervals) included in the first V time interval. The plurality of channel circuits may indicate a channel circuit connected to a plurality of sub-pixels of the display panel 210.

For example, the display driving circuit 230 may perform repairing 860 for the plurality of channel circuits as the second V time interval is triggered at the time 832. For example, the display driving circuit 230 may disconnect a connection between a defective channel circuit and a sub-pixel corresponding to the channel circuit from among the plurality of channel circuits and change a channel circuit (e.g., a dummy channel circuit) different from the sub-pixel.

For example, the display driving circuit 230 may control to transmit a control signal 870 and a light emitting signal 880 in response to the repairing 860. For example, the display driving circuit 230 may control a gate driver to transmit the control signal 870 for driving the transistor. The display driving circuit 230 may control a light emitting driver to transmit the light emitting signal 880 for emitting the sub-pixels based on the transistor. In FIG. 8, it is illustrated that the repairing 860 is performed at the time 832, the control signal 870 is outputted at the time 833, and the light emitting signal 880 is outputted at the time 834, but an embodiment of the present disclosure is not limited thereto. For example, at the time 832, the repairing 860 may be performed and the control signal 870 may be outputted together, and the light emitting signal 880 may be outputted after the time 832.

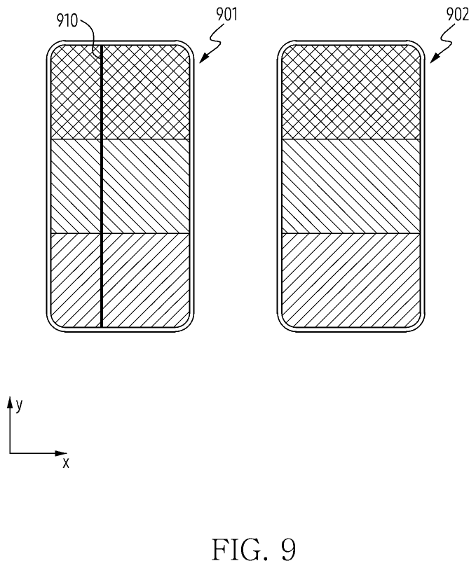

FIG. 9 illustrates an example of an output state of a display panel according to a method of changing a channel circuit connected to the display panel of a source driver.

Referring to FIG. 9, an example 901 of a display panel 210 outputting an image in the presence of a defect and an example 902 of the display panel 210 outputting an image based on a changed channel circuit according to an embodiment of the present disclosure are illustrated. The defect may occur in a manufacturing process producing an electronic device 101 or in a process of using the electronic device 101. For example, the defect may include damage to channel circuits in a source driver 352 of the electronic device 101 based on electrical damage (e.g., EOS or ESD).

Referring to the example 901, a defect 910 may be formed on the display panel 210 of the electronic device 101. For example, the defect 910 may be formed in a vertical direction (e.g., in a y-axis direction) in an area of the display panel 210. Referring to the example 902, the defect 910 in the vertical direction occurring in the example 901 may be repaired. The defect 910 may be damage caused by outputting inappropriate data (or a voltage) from a portion of signals outputted via a plurality of channel circuits from the source driver 352. A device and a method for changing a channel circuit according to an embodiment of the present disclosure may eliminate the defect 910 by identifying a channel circuit corresponding to the defect 910 and changing the identified channel circuit to another channel circuit.

For example, the display driving circuit 230 may perform identifying (or sensing) whether the defect exists with respect to the plurality of channel circuits and changing (or repairing) a channel circuit in which a defect exists to another channel circuit, whenever the display panel 210 changes from an off state to an on state. For example, the display driving circuit 230 may perform the operation whenever a command is received from the processor 120 as an event for changing the state of the display panel 210 is identified.

Referring to the above, the device and the method for changing the channel circuit according to an embodiment of the present disclosure may reduce a defect rate that may occur in the process of producing and manufacturing the electronic device. Also, the device and the method for changing the channel circuit according to the embodiment of the present disclosure may improve the defect displayed via the display even when the damage occurs in the process of using the electronic device.

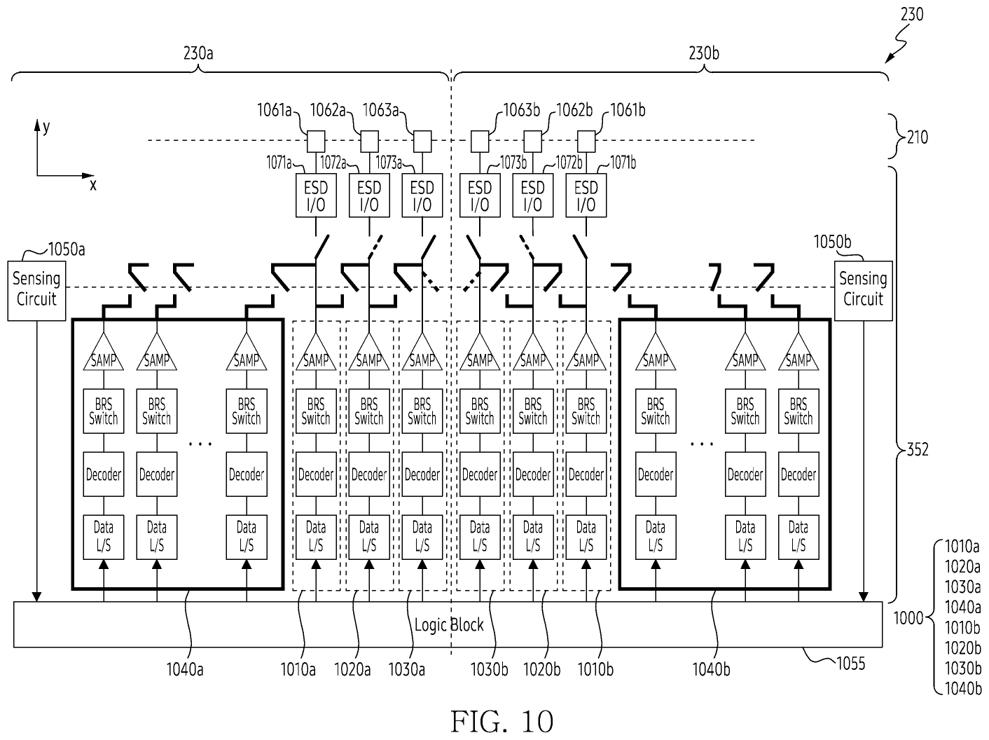

FIG. 10 illustrates an example of a display driving circuit including a channel circuit set. The display driving circuit may be understood substantially the same as the display driving circuit 230 of FIG. 2. The display driving circuit may be referred to as a control circuit.

The display driving circuit 230 of FIG. 10 may include the display driving circuit 230 of FIG. 5A. A description of the display driving circuit 230 of FIG. 5A may be applied to the display driving circuit 230 of FIG. 10 in substantially the same manner. Therefore, hereinafter, a content overlapping with FIG. 5A will be omitted.

Referring to FIG. 10, the display driving circuit 230 may include a display panel 210, a source driver 352, and a logic block 1055. The display driving circuit 230 may include a first area 230a and a second area 230b. For example, the first area 230a may indicate an area corresponding to a left side of the display panel 210 based on an x-axis direction, and the second area 230b may indicate an area corresponding to a right side of the display panel 210. The first area 230a and the second area 230b may indicate a virtual divided area. For example, in a case that the display panel 210 supports 1080*2400 (width*length) resolution, the first area 230a may include channel circuits corresponding to 540 lines on the left and at least one dummy channel circuit. The second area 230b may include channel circuits corresponding to 540 lines on the right and at least one dummy channel circuit. The example is merely an example for convenience of a description, and an embodiment of the present disclosure is not limited thereto.

For example, the display panel 210 may include a structure for visually representing an image outside an electronic device 101. For example, the display panel 210 may include output pads 1061a, 1062a, and 1063a in the first area 230a. The display panel 210 may include output pads 1061b, 1062b, and 1063b in the second area 230b. For example, the output pads 1061a, 1062a, 1063a, 1061b, 1062b, and 1063b may correspond to a plurality of sub-pixels included in the display panel 210.

For example, the logic block 1055 may indicate at least one component of the display driving circuit 230 for processing data transmitted to a channel circuit set 1000 in the source driver 352.

For example, the source driver 352 may include the channel circuit set 1000, sensing circuits 1050a and 1050b, and input/output ports 1071a, 1072a, 1073a, 1071b, 1072b, and 1073b (e.g., ESD I/O). For example, in the first area 230a, the channel circuit set 1000 may include a plurality of channel circuits 1010a, 1020a, 1030a, and 1040a. For example, the channel circuit set 1000 may include the channel circuits 1010a, 1020a, and 1030a corresponding to the input/output ports 1071a, 1072a, and 1073a. For example, the channel circuit 1010a may be connected to the output pad 1061a via the input port 1071a. The channel circuit 1020a may be connected to the output pad 1062a via the input port 1072a. The channel circuit 1030a may be connected to the output pad 1063a via the input port 1073a. Being connected with the output pad may be understood in substantially the same manner as the channel circuit connected with the sub-pixel. For example, in the first area 230a, the channel circuit set 1000 may include at least one channel circuit 1040a not corresponding to the input/output ports 1071a, 1072a, and 1073a. For example, the at least one channel circuit 1040a may indicate a spare channel circuit that is not connected to the input/output port and the output pad. The at least one channel circuit 1040a may be referred to as a dummy channel circuit.

For example, in the second area 230b, the channel circuit set 1000 may include the plurality of channel circuits 1010b, 1020b, 1030b, and 1040b. For example, the channel circuit set 1000 may include the channel circuits 1010b, 1020b, and 1030b corresponding to the input/output ports 1071b, 1072b, and 1073b. For example, the channel circuit 1010b may be connected to the output pad 1061b via the input port 1071b. The channel circuit 1020b may be connected to the output pad 1062b via the input port 1072b. The channel circuit 1030b may be connected to the output pad 1063b via the input port 1073b. Being connected with the output pad may be understood in substantially the same manner as the channel circuit connected with the sub-pixel. For example, in the second area 230b, the channel circuit set 1000 may include at least one channel circuit 1040b not corresponding to the input/output ports 1071b, 1072b, and 1073b.

For example, each of the sensing circuits 1050a and 1050b may include a comparator. The comparator may compare a voltage of a signal detected by the sensing circuit to a reference voltage. For example, the reference voltage may be set differently according to a gradation. For example, the reference voltage may be included in a reference voltage set including a plurality of reference voltages. For example, the sensing circuit 1050a may be connected to an output terminal of a plurality of channel circuits 1010a, 1020a, 1030a, and 1040a. For example, the sensing circuit 1050b may be connected to an output terminal of a plurality of channel circuits 1010b, 1020b, 1030b, and 1040b. For example, the sensing circuits 1050a and 1050b may detect a voltage of a signal outputted from each of the plurality of channel circuits 1010a, 1020a, 1030a, 1040a, 1010b, 1020b, 1030b, and 1040b via a sensing line. The output terminal may include an output terminal of an amplifier included in the channel circuit. For example, the sensing circuits 1050a and 1050b may transmit information (e.g., the voltage of the signal and a comparison result between the voltage of the signal and the reference voltage) on the detected signal to the logic block 1055. Accordingly, the display driving circuit 230 may identify whether a defect occurred in a specific channel circuit based on the information on the signal. For example, the logic block 1055 may identify whether a defect occurred in the specific channel circuit, based on the information on the signal.

In FIG. 10, the channel circuit set 1000 including six channel circuits 1010a, 1020a, 1030a, 1010a, 1020b, and 1030b connected to the input/output port is illustrated, but the number of channel circuits of FIG. 10 is merely illustrative for convenience of a description, and an embodiment of the present disclosure is not limited thereto. For example, the number of channel circuits connected to the input/output ports included in the channel circuit set 1000 may be identified based on the display panel 210 (or sub-pixel).

Referring to FIGS. 1 to 10, a device and a method for changing a channel circuit according to an embodiment of the present disclosure may identify (or sense) whether damage has occurred to the channel circuit by measuring a voltage of a signal outputted from the channel circuit and comparing the measured voltage with a reference voltage with respect to the channel circuit connected to a sub-pixel of a display panel. The device and the method for changing the channel circuit according to an embodiment of the present disclosure may disconnect a connection between the damaged channel circuit and the sub-pixel and connect (or repair) another channel circuit and the sub-pixel. Accordingly, the device and the method for changing the channel circuit according to an embodiment of the present disclosure may reduce a defect rate that may occur in a process of producing and manufacturing an electronic device. Also, the device and the method for changing the channel circuit according to the embodiment of the present disclosure may improve the defect displayed via a display even when the damage occurs in the process of using the electronic device.

The effects that may be obtained from the present disclosure are not limited to those described above, and any other effects not mentioned herein will be clearly understood by those having ordinary knowledge in the art to which the present disclosure belongs, from the following description.

As described above, an electronic device 101 may comprise memory storing instructions. The electronic device 101 may comprise a processor 120. The electronic device 101 may comprise a display panel 210 including a plurality of sub-pixels. The electronic device 101 may comprise a control circuit 230 including a gate driver 353 for controlling driving of each of the plurality of sub-pixels and a source driver 352 for controlling a data voltage for each of the plurality of sub-pixels. The source driver 352 may include a channel circuit set including a plurality of channel circuits respectively connected to the plurality of sub-pixels and a first channel circuit disconnected from the plurality of sub-pixels, and a sensing circuit. The instructions, when executed by the control circuit 230, may cause the electronic device 101 to identify an event for changing a first state that the display panel 210 is off to a second state that the display panel 210 is on. The instructions, when executed by the control circuit 230, may cause the electronic device 101 to, in response to the event, respectively identify, via the sensing circuit, signals outputted via the plurality of channel circuits in the first state. The instructions, when executed by the control circuit 230, may cause the electronic device 101 to disconnect a second channel circuit outputting a signal having a voltage different from a reference voltage from among the plurality of channel circuits in the first state from a sub-pixel connected to the second channel circuit, and connect the sub-pixel to the first channel circuit. The instructions, when executed by the control circuit 230, may cause the electronic device 101 to display an image on the display panel 210 based on the plurality of channel circuits including the first channel circuit in the second state changed from the first state according to the event.

According to an embodiment, the instructions, when executed by the control circuit 230, may cause the electronic device 101 to, in the first state, respectively identify, via the sensing circuit, a first set of signals outputted via the plurality of channel circuits in a first partial time interval from among a plurality of partial time intervals in a first time interval triggered in response to the event. The instructions, when executed by the control circuit 230, may cause the electronic device 101 to, in the first state, respectively identify, via the sensing circuit, a second set of signals outputted via the plurality of channel circuits in a second partial time interval subsequent to the first partial time from among the plurality of partial time intervals.

According to an embodiment, the instructions, when executed by the control circuit 230, may cause the electronic device 101 to sequentially compare, via the sensing circuit in the first partial time interval, a first reference voltage to the first set of signals corresponding to the plurality of channel circuits. The instructions, when executed by the control circuit 230, may cause the electronic device 101 to sequentially compare, via the sensing circuit in the second partial time interval, a second reference voltage to the second set of signals corresponding to the plurality of channel circuits. The first reference voltage and the second reference voltage may be included in a reference voltage set identified based on a gradation capable of being represented by a channel circuit.

According to an embodiment, the instructions, when executed by the control circuit 230, may cause the electronic device 101 to generate a flag for identifying the second channel circuit in response to identifying the second channel circuit. The instructions, when executed by the control circuit 230, may cause the electronic device 101 to, based on the flag, disconnect the sub-pixel from the second channel circuit and connect the sub-pixel to the first channel circuit.

According to an embodiment, the signals may be identified in a first time interval triggered in response to the event. The sub-pixel may be disconnected from the second channel circuit and be connected to the first channel circuit in a second time interval subsequent to the first time interval.

According to an embodiment, the sub-pixel may be connected to the first channel circuit before the display panel 210 is changed from the first state to the second state.

According to an embodiment, the instructions, when executed by the control circuit 230, may cause the electronic device 101 to receive, from the processor 120, a command for changing a state of the display panel 210 in response to the event. The instructions, when executed by the control circuit 230, may cause the electronic device 101 to transmit to the display panel 210, a signal for changing the display panel 210 from the first state to the second state based on the command.

According to an embodiment, the instructions, when executed by the control circuit 230, may cause the electronic device 101 to, in response to identifying the signal having the voltage different from the reference voltage, change at least one switch connecting the sub-pixel and the second channel circuit from an on state to an off state, and change at least one another switch connecting the sub-pixel and the first channel circuit from an off state to an on state.

According to an embodiment, the instructions, when executed by the control circuit 230, may cause the electronic device 101 to drive the gate driver 353 in response to the sub-pixel being connected to the first channel circuit.

According to an embodiment, the event may include a gesture, a touch input, or an input for a button exposed to an outside of the electronic device 101, for changing the first state to the second state.

According to an embodiment, a number of the plurality of channel circuits may be changed based on a number of the plurality of sub-pixels identified according to a pentile.

According to an embodiment, the electronic device 101 may further comprise another sensing circuit. The sensing circuit may be connected to a first set of sub-pixels from among the plurality of sub-pixels and a first set of channel circuits from among the plurality of channel circuits. The another sensing circuit may be connected to a second set of sub-pixels excluding the first set of sub-pixels from among the plurality of sub-pixels and a second set of channel circuits excluding the first set of channel circuits from among the plurality of channel circuits.

According to an embodiment, each of the plurality of channel circuits may include at least one of a level shifter, a decoder, a switch, or an amplifier. The sensing circuit may include a comparator.

As described above, a method performed by an electronic device 101 may comprise identifying an event for changing a first state that a display panel 210 including a plurality of sub-pixels of the electronic device 101 is off to a second state that the display panel 210 is on. The method may comprise, in response to the event, respectively identifying signals outputted via a plurality of channel circuits in a source driver 352 of the electronic device 101, via a sensing circuit in the source driver 352, in the first state. The method may comprise disconnecting a second channel circuit outputting a signal having a voltage different from a reference voltage from among the plurality of channel circuits in first state from a sub-pixel connected, directly or indirectly, to the second channel circuit, and connecting the sub-pixel to the first channel circuit. The method may comprise, displaying an image on the display panel 210 based on the plurality of channel circuits including the first channel circuit in the second state changed from the first state according to the event.

According to an embodiment, the method may comprise, in the first state, respectively identifying, via the sensing circuit, a first set of signals outputted via the plurality of channel circuits in a first partial time interval from among a plurality of partial time intervals in a first time interval triggered in response to the event. The method may comprise, in the first state, respectively identifying, via the sensing circuit, a second set of signals outputted via the plurality of channel circuits in a second partial time interval subsequent to the first partial time from among the plurality of partial time intervals.

According to an embodiment, the method may comprise sequentially comparing, via the sensing circuit in the first partial time interval, a first reference voltage to the first set of signals corresponding to the plurality of channel circuits. The method may comprise sequentially comparing, via the sensing circuit in the second partial time interval, a second reference voltage to the second set of signals corresponding to the plurality of channel circuits. The first reference voltage and the second reference voltage may be included in a reference voltage set identified based on a gradation capable of being represented by a channel circuit.

According to an embodiment, the method may comprise generating a flag for identifying the second channel circuit in response to identifying the second channel circuit. The method may comprise, based on the flag, disconnecting the sub-pixel from the second channel circuit and connecting the sub-pixel to the first channel circuit. “Based on” as used herein covers based at least on.

According to an embodiment, the signals may be identified in a first time interval triggered in response to the event. The sub-pixel may be disconnected from the second channel circuit and be connected to the first channel circuit in a second time interval subsequent to the first time interval.

According to an embodiment, the sub-pixel may be connected, directly or indirectly, to the first channel circuit before the display panel 210 is changed from the first state to the second state.

According to an embodiment, the method may comprise identifying a command for changing a state of the display panel 210 in response to the event. The method may comprise changing the display panel 210 from the first state to the second state based on the command.

According to an embodiment, the method may comprise, in response to identifying the signal having the voltage different from the reference voltage, changing a switch connecting the sub-pixel and the second channel circuit from an on state to an off state, and changing at least one another switch connecting the sub-pixel and the first channel circuit from an off state to an on state.

According to an embodiment, the method may comprise driving the gate driver 353 in response to the sub-pixel being connected to the first channel circuit.

According to an embodiment, the event may include a gesture, a touch input, or an input for a button exposed to an outside of the electronic device 101, for changing the first state to the second state.

According to an embodiment, a number of the plurality of channel circuits may be changed based on a number of the plurality of sub-pixels identified according to a pentile.

According to an embodiment, the electronic device 101 may further comprise another sensing circuit. The sensing circuit may be connected, directly or indirectly, to a first set of sub-pixels from among the plurality of sub-pixels and a first set of channel circuits from among the plurality of channel circuits. The another sensing circuit may be connected, directly or indirectly, to a second set of sub-pixels excluding the first set of sub-pixels from among the plurality of sub-pixels and a second set of channel circuits excluding the first set of channel circuits from among the plurality of channel circuits.

According to an embodiment, each of the plurality of channel circuits may include at least one of a level shifter, a decoder, a switch, or an amplifier. The sensing circuit may include a comparator.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element. Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120, comprising processing circuitry) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions;
a processor comprising processing circuitry;
a display panel including a plurality of sub-pixels; and
control circuitry including a gate driver for controlling driving of each of the plurality of sub-pixels and a source driver for controlling a data voltage for each of the plurality of sub-pixels,
wherein the source driver includes a channel circuit set including a plurality of channel circuits respectively connected to the plurality of sub-pixels and a first channel circuit disconnected from the plurality of sub-pixels, and sensing circuitry,
wherein the instructions, when executed by the control circuitry, are configured to cause the electronic device to:
identify an event for changing a first state that the display panel is off to a second state that the display panel is on,
in response to the event, respectively identify, via at least the sensing circuitry, signals output via the plurality of channel circuits in the first state,
disconnect a second channel circuit outputting a signal having a voltage different from a reference voltage from among the plurality of channel circuits in the first state from a sub-pixel connected to the second channel circuit, and connect the sub-pixel to the first channel circuit, and
display an image via the display panel based on the plurality of channel circuits including the first channel circuit in the second state changed from the first state based on the event.

2. The electronic device of claim 1,
wherein the instructions, when executed by the control circuitry, cause the electronic device to:
in the first state, respectively identify, via at least the sensing circuitry, a first set of signals output via the plurality of channel circuits in a first partial time interval from among a plurality of partial time intervals in a first time interval triggered in response to the event, and
in the first state, respectively identify, via at least the sensing circuitry, a second set of signals output via the plurality of channel circuits in a second partial time interval subsequent to the first partial time from among the plurality of partial time intervals.

3. The electronic device of claim 2,
wherein the instructions, when executed by the control circuitry, cause the electronic device to:
sequentially compare, via at least the sensing circuitry in the first partial time interval, a first reference voltage to the first set of signals corresponding to the plurality of channel circuits, and
sequentially compare, via at least the sensing circuitry in the second partial time interval, a second reference voltage to the second set of signals corresponding to the plurality of channel circuits, and
wherein the first reference voltage and the second reference voltage are included in a reference voltage set identified based on a gradation capable of being represented by a channel circuit.

4. The electronic device of claim 1,
wherein the instructions, when executed by the control circuitry, cause the electronic device to:
generate a flag for identifying the second channel circuit in response to identifying the second channel circuit, and
based on the flag, disconnect the sub-pixel from the second channel circuit and connect the sub-pixel to the first channel circuit.

5. The electronic device of claim 4,
wherein the signals are identified in a first time interval triggered in response to the event, and
wherein the sub-pixel is configured to be disconnected from the second channel circuit and connected to the first channel circuit in a second time interval subsequent to the first time interval.

6. The electronic device of claim 1,
wherein the sub-pixel is configured to be connected to the first channel circuit before the display panel is changed from the first state to the second state.

7. The electronic device of claim 1,
wherein the instructions, when executed by the control circuitry, cause the electronic device to:
receive, from the processor, a command for changing a state of the display panel in response to the event, and
transmit, to the display panel, a signal for changing the display panel from the first state to the second state based on the command.

8. The electronic device of claim 1,
wherein the instructions, when executed by the control circuitry, cause the electronic device to:
in response to identifying the signal having the voltage different from the reference voltage, change at least one switch connecting the sub-pixel and the second channel circuit from an on state to an off state, and change at least one another switch connecting the sub-pixel and the first channel circuit from an off state to an on state.

9. The electronic device of claim 1,
wherein the instructions, when executed by the control circuitry, cause the electronic device to:
drive the gate driver in response to the sub-pixel being connected to the first channel circuit.

10. The electronic device of claim 1,
wherein the event includes at least one of a gesture, a touch input, or an input for a button exposed to an outside of the electronic device, for changing the first state to the second state.

11. The electronic device of claim 1,
wherein a number of the plurality of channel circuits is changed based on a number of the plurality of sub-pixels identified according to a pentile.

12. The electronic device of claim 1,
wherein the electronic device further comprises another sensing circuitry,
wherein the sensing circuitry is connected to a first set of sub-pixels from among the plurality of sub-pixels and a first set of channel circuits from among the plurality of channel circuits, and
wherein the another sensing circuitry is connected to a second set of sub-pixels excluding the first set of sub-pixels from among the plurality of sub-pixels and a second set of channel circuits excluding the first set of channel circuits from among the plurality of channel circuits.

13. The electronic device of claim 1,
wherein each of the plurality of channel circuits includes at least one of a level shifter, a decoder, a switch, or an amplifier, and
wherein the sensing circuitry includes a comparator.

14. A method performed by an electronic device comprising:
identifying an event for changing a first state that a display panel including a plurality of sub-pixels of the electronic device is off to a second state that the display panel is on,
in response to the event, respectively identifying signals output via a plurality of channel circuits in a source driver of the electronic device, via at least a sensing circuitry in the source driver, in the first state,
disconnecting a second channel circuit outputting a signal having a voltage different from a reference voltage from among the plurality of channel circuits in the first state from a sub-pixel connected to the second channel circuit, and connecting the sub-pixel to first channel circuit, and
displaying an image on the display panel based on the plurality of channel circuits including the first channel circuit in the second state changed from the first state based on the event.

15. The method of claim 14, comprising:
in the first state, respectively identifying, via the sensing circuitry, a first set of signals output via the plurality of channel circuits in a first partial time interval from among a plurality of partial time intervals in a first time interval triggered in response to the event, and
in the first state, respectively identifying, via at least the sensing circuitry, a second set of signals output via the plurality of channel circuits in a second partial time interval subsequent to the first partial time from among the plurality of partial time intervals.

16. The method of claim 15, comprising:
sequentially comparing, via the sensing circuitry in the first partial time interval, a first reference voltage to the first set of signals corresponding to the plurality of channel circuits; and
sequentially comparing, via the sensing circuitry in the second partial time interval, a second reference voltage to the second set of signals corresponding to the plurality of channel circuits,
wherein the first reference voltage and the second reference voltage are included in a reference voltage set identified based on a gradation capable of being represented by a channel circuit.

17. The method of claim 14, comprising:
generating a flag for identifying the second channel circuit in response to identifying the second channel circuit; and
based on the flag, disconnecting the sub-pixel from the second channel circuit and connecting the sub-pixel to the first channel circuit.

18. The method of claim 17, wherein the signals are identified in a first time interval triggered in response to the event, and
wherein the sub-pixel is disconnected from the second channel circuit and connected to the first channel circuit in a second time interval subsequent to the first time interval.

19. The method of claim 14, wherein the sub-pixel is connected to the first channel circuit before the display panel is changed from the first state to the second state.

20. The method of claim 14, comprising:
in response to the event, identifying a command for changing a state of the display panel; and
changing the display panel from the first state to the second state based on the command.
